(19) United States
(12) Patent Application Publication
(10) Pub. No.: US 2008/0163185 A1
(43) Pub. Date: Jul. 3, 2008

(54) Delay-load optimizer

(75) Inventor: Kevin Goodman, Alpharetta, GA (US)

Correspondence Address: KING & SPALDING LLP, 1180 PEACHTREE STREET, ATLANTA, GA, 30309-3521, US

(73) Assignee: RTO Software, Inc., Alpharetta, GA (US)

(21) Appl. No.: 11/647,675

(22) Filed: Dec. 29, 2006

(51) Int. Cl. G06F 9/45

(52) U.S. Cl. 717/151

(57) ABSTRACT

An application program includes an executable file and at least one other component (e.g. a DLL). A copy of the executable file is created and its import address table is modified by replacing a reference to the component with a reference to a delay-load component and replacing a reference to an imported function included within the component with a reference to a delay-load function included within the delay-load component. The delay-load function is designed to load the component into memory upon execution of a function call designed to access the imported function. The copy of the executable file may be saved as an alternate data stream of the original executable file. The copy of the executable file may be loaded into memory in response to a command for initializing the application program. As a result, the delay-load component will be loaded into memory instead of the component.

### TECHNICAL FIELD

The invention relates generally to optimizing the load/initialization performance of a compiled application program. More specifically, the invention relates to optimizing the load/initialization performance of a compiled application program by delaying the loading into memory of some or all of its components until such components are actually needed and determined to be available.

### BACKGROUND OF THE INVENTION

When a software application program is initiated for execution in a typical computing environment, the computer operating system creates a process and loads the process components into memory. By way of example, the Microsoft Windows operating system (“Windows”) uses a technique known as memory-mapping to load the components of a process from persistent storage (e.g., disk or tape) into memory (e.g., random access memory (“RAM”)). The components of a process include the executable file and any dynamic linked libraries (“DLLs”) and other data files associated with the application program. The various functions of the application program are typically included in the DLLs. Several DLLs are associated with the typical application program.

All DLLs associated with an application program are normally loaded into memory upon initialization of a process. In this way, each function of the application program is made available and will properly execute when invoked by the user. However, certain functions of an application program are not often used or required by a given user or set of users. Therefore, loading all associated DLLs into memory can unnecessarily, and sometimes significantly, impact the load/initialization performance of the process and consume memory and/or other system resources. Accordingly, it is sometimes desirable to postpone loading into memory certain DLLs and/or other components until they are actually needed by a particular process.

In some cases, such as in a terminal server environment, the same application program may be run on two different operating system platforms (e.g., two different versions of Windows) and may make a call to a DLL or a particular function of a DLL that is not available on one of the platforms. Even though the application program may be able to execute sufficiently without the unavailable DLL or function, it will usually fail to load properly due to linking errors or will experience a run-time error or other software exception when a call is made to the unavailable function(s). Therefore, it is sometimes desirable to prevent an application from trying to load and make function calls to DLLs and/or functions that are not available.

It is known in the art to build a “delay-load” function into an application program at compile-time. Such a function is configured to delay the loading of pre-selected DLLs into memory until they are actually needed by the application program. However, the compile-time solution of the prior art does not provide flexibility for delay-loading any DLLs other than those pre-selected by the software designers. Depending on the operating environment and resource usage patterns, the compile-time decisions regarding which DLLs to delay-load may not be valid at run-time. To delay-load additional components or stop delay-loading any functions of the application program, the prior art solution requires the application source code to be modified and re-compiled. Therefore, there remains a need for a solution that can delay-load components of a compiled application program without the need to modify its source code.

### SUMMARY OF THE INVENTION

The invention satisfies the above-described need by providing systems, methods and related computer-readable media for delay-loading components of a compiled application program. In the context of the invention, it is assumed that a compiled application program includes an executable file and at least one other component, such as a DLL. The term “executable file” is used herein to refer to a computer file comprising an instruction for performing at least one function. For example, an executable file can be a portable executable file with a “.exe” or “.dll” file extension. The executable file includes an import address table that contains a reference to the component and a reference to an imported function included within the component. The references within the import address table may be names or ordinals used to identify the component and the imported function.

In accordance with certain embodiments of the invention, a copy of the executable file is created and its import address table is modified by replacing the reference to the component with a reference to a delay-load component and replacing the reference to the imported function with a reference to a delay-load function included within the delay-load component. The delay-load function is designed to load the component into memory upon execution of a function call that is designed to access the imported function. The copy of the executable file may optionally be saved as an alternate data stream of an original version of the executable file.

The copy of the executable file is loaded into memory in response to a command for initializing the compiled application program. As a result, the delay-load component will be loaded into memory instead of the component. A file system filter driver or other suitable program module or function may be employed to load the copy of the executable file into memory in response to a command for initializing the compiled application program. The function call designed to access the imported function refers to an in-memory address within the modified import address table that stores the reference to the delay-load function. Accordingly, execution of the function call causes the delay-load function to be executed.

The delay-load function is designed to locate and examine the function call within the copy of the executable file loaded in memory to determine the in-memory address within the modified import address table to which the function call refers. The delay-load function may locate the function call by examining a stack register to determine the in-memory address of the function call. The in-memory address within the modified import address table to which the function call refers may be converted to an offset. The delay-load function then examines the import address table of the original executable file (in persistent storage), to identify the imported function and the component, based on the offset. After identifying the component, the delay-load function attempts to load it into memory.

In response to loading the component into memory, the in-memory address of the imported function is determined. Then, at the previously determined in-memory address within the modified import address table, the reference to the delay-load function is replaced with a reference to the in-memory address of the imported function. Processing control is then transferred to the imported function. In the event that the component is not available to be loaded into memory, any software exception raised may be trapped and processing control is transferred to an in-memory address following the function call within the copy of the executable file. Similarly, if the imported function is not available in memory, any software exception raised may be trapped and processing control is transferred to the in-memory address following the function call.

After the component is loaded into memory by the delay-load function, it may be released from memory in response to determining that the imported function or any of the component's other functions has not frequently been used or is not expected to be frequently used. As an example, the component may be released from memory if the imported function has not been called within a configurable time limit and/or the component has not previously been released from memory more than a configurable threshold number of times. If the component is released from memory, the reference in the modified import address table that refers to the in-memory address of the imported function is replaced with a reference to the in-memory address of the delay-load function. If the imported function is subsequently needed again, it can be reloaded into memory on-demand by the delay-load function.

These and other aspects, features and embodiments of the invention will become apparent to a person of ordinary skill in the art upon consideration of the following detailed description of illustrated embodiments exemplifying the best mode for carrying out the invention as presently perceived.

### BRIEF DESCRIPTION OF THE DRAWINGS

FIG. 1 is a block diagram of an exemplary computing environment in which certain embodiments of the invention may be implemented.

FIG. 2 is a block diagram comparing, in the abstract, an original (un-optimized) executable file with an optimized executable file, in accordance with certain embodiments of the invention.

FIG. 3 is a flow chart illustrating an exemplary method for creating an optimized executable file, in accordance with certain embodiments of the invention.

FIG. 4 is flow chart illustrating an exemplary method for loading an optimized executable file into memory instead of an original (un-optimized) version of the executable file, in accordance with certain embodiments of the invention.

FIG. 5 is a block diagram showing, in the abstract, certain operations performed by an operating system's loader module when an optimized executable file is initialized.

FIG. 6 is a block diagram illustrating, in the abstract, certain operations performed when a delay-loaded DLL is loaded into memory in response to an executed function, in accordance with certain embodiments of the invention.

FIG. 7 is a flow chart illustrating an exemplary method for loading a delay-loaded DLL into memory in response to an executed function call, in accordance with certain embodiments of the invention.

FIG. 8 is a flow chart illustrating an exemplary method for unloading a delay-loaded DLL from memory, in accordance with certain embodiments of the invention.

FIG. 9 is a flow chart illustrating an exemplary method for determining when to unload a delay-loaded DLL from memory, in accordance with certain embodiments of the invention.

### DETAILED DESCRIPTION OF EXEMPLARY EMBODIMENTS

The invention provides systems and methods for delay-loading components of a compiled application program. That is, the invention is designed to delay the loading into memory of some or all of the components of a compiled application program, without the need to modify the application's program source code. By delay-loading application program components, initialization/load performance is improved and memory resources can be conserved until the delay-loaded components are actually needed by the application program and determined to be available. As used herein, the term “delay-loaded” is intended to signify an application program component that has not been loaded into memory upon initialization of the application program, but can be loaded into memory when needed.

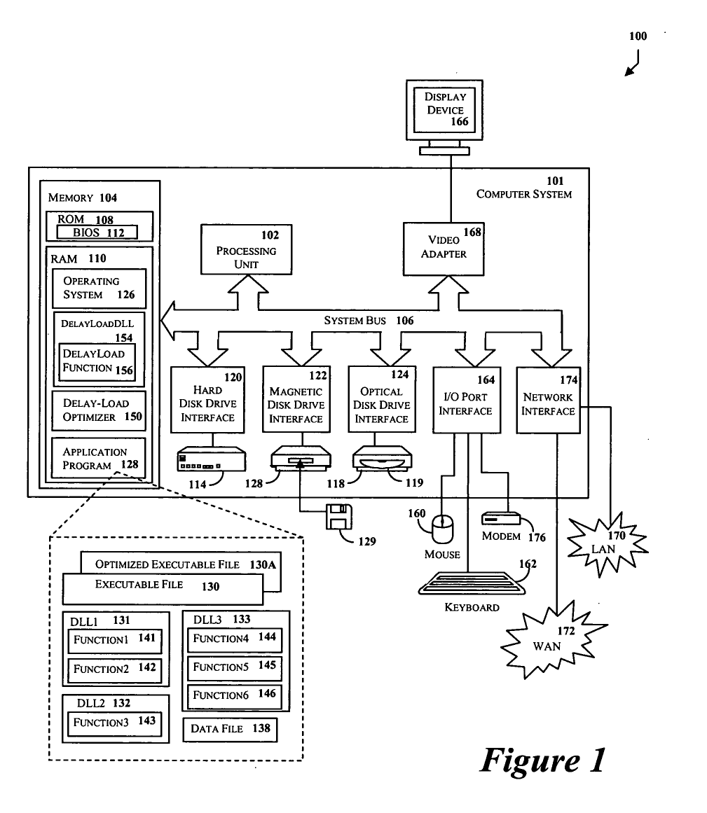

The following description of exemplary embodiments of the invention will refer to the attached drawings, in which like numerals indicate like elements throughout the several figures. FIG. 1 and the following discussion are intended to provide a brief and general description of a suitable computing environment 100 in which certain embodiments of the invention may be implemented. The computing environment 100 is intended to be representative of any computer system, including a personal computer or other workstation, a host or server (e.g., a terminal server), or a even portable or handheld computer device. A person of ordinary skill in the art will recognize that the invention may be implemented using computer system configurations other than the one shown in FIG. 1.

The computer system 101 includes a processing unit 102, a system memory 104 and a system bus 106 that couples the system memory 104 to the processing unit 102. The system memory 104, which includes read only memory (ROM) 108 and random access memory (RAM) 110, is logically divided into a plurality of in-memory addresses. A basic input/output system (BIOS) 112, containing basic routines that help to transfer information between elements within the computer system 101, such as during start-up, is stored in ROM 108.

The computer system 101 further includes a hard disk 114, a magnetic disk drive 116, e.g., to read from or write to a removable disk 117, and an optical disk drive 118, e.g., for reading a CD-ROM disk 119 or to read from or write to other optical media. The hard disk 114, magnetic disk drive 116, and optical disk drive 118 are connected to the system bus 106 by a hard disk drive interface 120, a magnetic disk drive interface 122, and an optical drive interface 124, respectively. The drives and their associated computer-readable media provide nonvolatile (i.e., persistent) storage for the computer system 101. Although the description of computer-readable media above refers to a hard disk, a removable magnetic disk and a CD-ROM disk, it should be appreciated by a person of ordinary skill in the art that other types of media that are readable by a computer system, such as magnetic cassettes, flash memory cards, digital video disks, Bernoulli cartridges, and the like, may also be used in the exemplary operating environment.

A number of program modules may be stored in the persistent storage (e.g., hard disk 114) and the memory 104 (e.g., RAM 110), including an operating system 126 and one or more application program 128. An application program 128 may have several components, such as an executable file 130, one or more DLL (e.g., DLL1 131, DLL2, 132 and DLL3 133), one or more data file 138, etc. The functions of an application program 128 may be stored in one or more DLL. As shown by way of illustration in FIG. 1, DLL1 131 includes Function1 141 and Function2 142; DLL2 132 includes Function3 143; and DLL3 133 includes Function4 144, Function5 145 and Function6 146. In certain embodiments, as will be explained below, the invention may create an “optimized executable file” 130A, which is a modified copy of the original executable file 130.

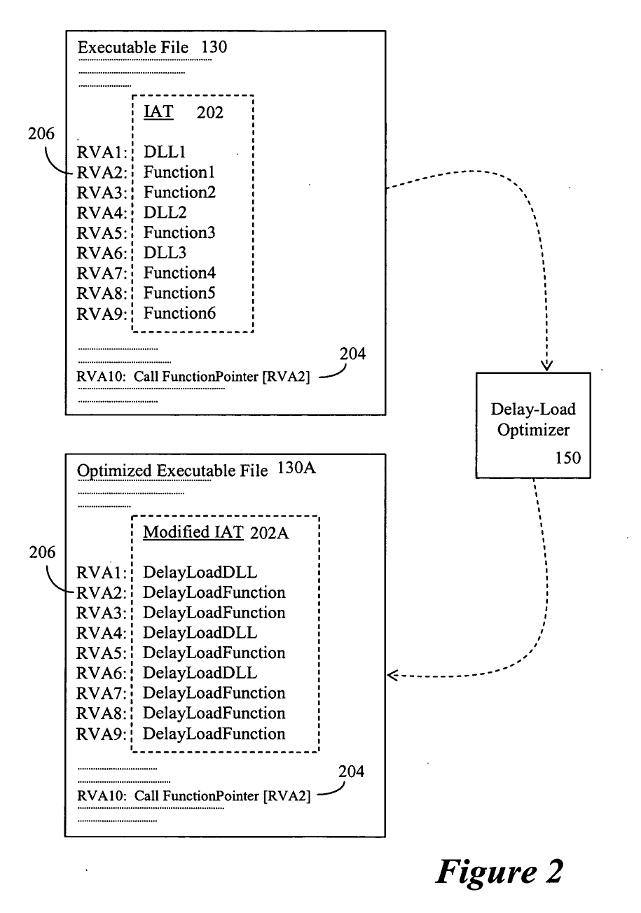

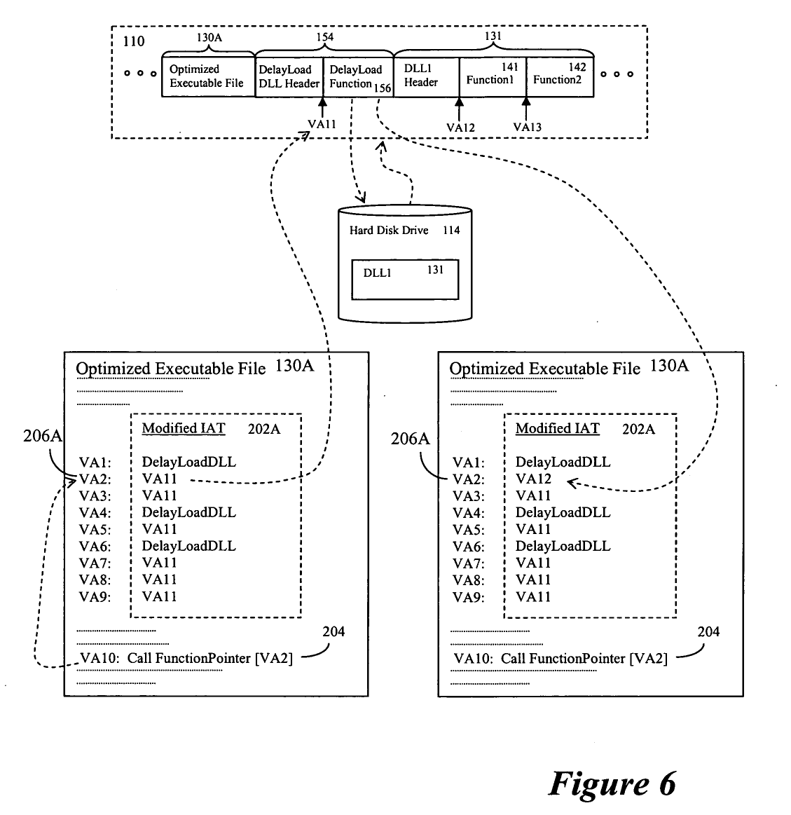

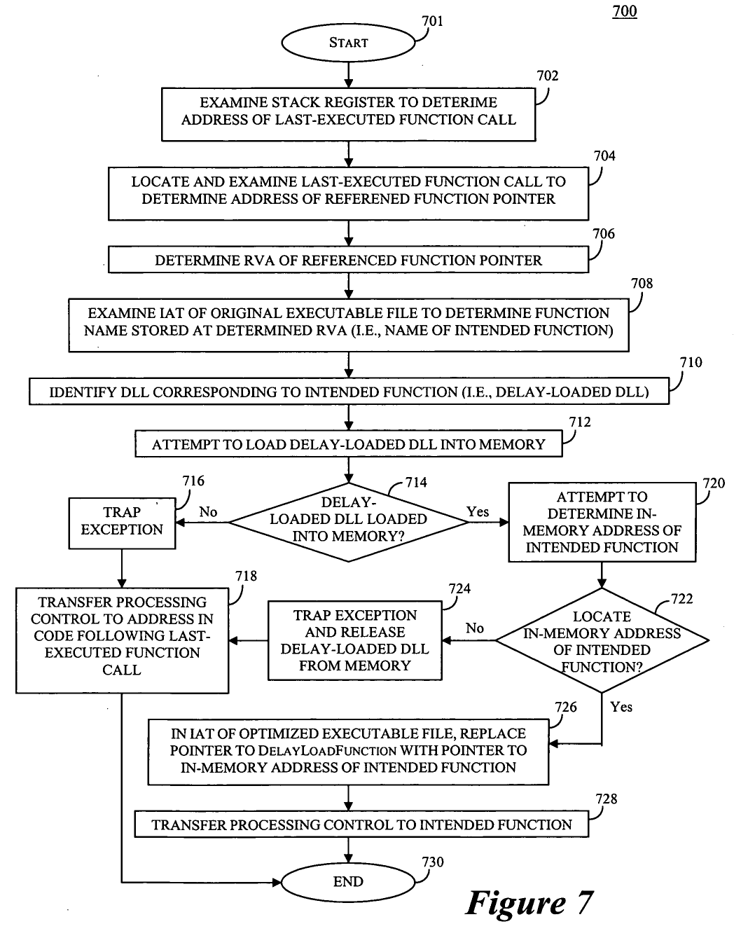

The invention may be implemented, at least in part, as a program module referred to herein as “Delay-Load Optimizer” 150 and a DLL referred to as “DelayLoadDLL” 154. DelayLoadDLL 154 includes a function referred to herein as “DelayLoadFunction” 156. In certain embodiments, the Delay-Load Optimizer 150 comprises computer-executable instructions for performing some or all of the methods described hereinafter with reference to FIGS. 2, 3, 4, 8 and 9 and DelayLoadFunction 156 comprises computer-executable instructions for performing some or all of the methods described hereinafter with reference to FIGS. 6 and 7.

Various input/output devices may be connected to the exemplary computer system 101. For example, the typical computer system 101 will include a mouse 160 or other pointing device and a keyboard 162. Other input devices (not shown) may include a microphone, joystick, game pad, satellite dish, scanner, or the like. These and other input devices are often connected to the processing unit 102 through an I/O port interface 164 (e.g., serial port, game port, universal serial bus port, firewire port, parallel port, etc.) that is coupled to the system bus 106. A display device 166 is also connected to the system bus 106 via an interface, such as a video adapter 168. In addition to display devices 166, computer systems 101 typically include other peripheral output devices (not shown), such as speakers or printers.

The computer system 101 may operate in a networked environment using logical connections to one or more remote computer systems. The remote computer system may be a server, a router, a peer device or other common network node, and typically includes many or all of the elements described above relative to the computer system 101. The logical connections depicted in FIG. 1 include a local area network (LAN) 170 and a wide area network (WAN) 172. Such networking environments are commonplace in offices, enterprise-wide computer networks, intranets and the Internet.

When used in a LAN or WAN networking environment, the computer system 101 may be connected to the LAN 170 or WAN 172 through a network interface 174. The computer system 101 may also include a modem 176 or other means for establishing communications over a WAN 172, such as the Internet. The modem 176, which may be internal or external, may be connected to the system bus 106 via an I/O port interface 164. In a networked environment, program modules depicted relative to the computer system 101, or portions thereof, may be stored in remote memory storage devices. It will be appreciated that the network connections shown are exemplary and other means of establishing a communications link between computer systems may be used.

FIG. 2 is a block diagram comparing, in the abstract, an original (un-optimized) executable file 130 with an optimized executable file 130A, in accordance with certain embodiments of the invention. The optimized executable file 130A is a modified version of the original executable file 130. As will be explained, the optimized executable file 130A is configured to cause the operating system 126 to delay-load certain DLLs or other components of a compiled application program 128. In this manner, the delay-loaded components will not be loaded into memory 104 until they are actually needed and determined to be available. In the example of FIG. 2, the optimized executable file 130A is designed to cause each of hypothetical DLL1 131, DLL2 132 and DLL3 133 to be delay-loaded.

In the exemplary embodiments discussed herein, all executable files and other process components are described as being Win32 Portable Executable files. In addition, delay-loaded components are described herein as being DLLs. A person of ordinary skill in the art will appreciate, however, that the concepts of the invention can be extended to other operating systems and file formats. A person of ordinary skill in the art will also appreciate that the concepts of the invention can be applied to other types of process components, whether in the context of Win32 Portable Executable files or otherwise. Accordingly, the scope of the invention is not intended to be limited to the context of Win32 Portable Executable files, nor to delay-loading of DLLs.

As is well known in the art, all Win32 Portable Executable files include an import address table (“IAT”) 202. An IAT 202 is an array of pointers to all imported functions that will be used by the executable file. Before the executable file 130 is initialized, each position within the IAT 202 includes the name or ordinal of a DLL or an imported function. Upon initialization of the executable file 130, the operating system loader will replace each imported function name (or ordinal) in the IAT 202 with a pointer to the address in memory 104 at which the corresponding function is loaded. As is also well known in the art, offsets in a Win32 Portable Executable file in persistent storage are expressed as Relative Virtual Addresses (“RVA”) and in-memory addresses are referred to as “virtual addresses.”

In certain embodiments of the invention a Delay-Loader Optimizer 150 program module is designed to create the optimized executable file 130A. The optimized executable file 130A can be created as a copy of the original executable file 130 with a modified IAT 202A. Alternatively, the original executable file 130 could be modified and resaved as the optimized executable file 130A. However, some original executable files 130 are protected against modification and attempts to circumvent such protections could lead to system errors. In addition, modifying an original executable file 130 can make it more difficult to revert to a pre-optimized state.

In certain embodiments of the invention, the system 100 can include additional functionality for synchronizing the original executable file 130 with the optimized executable file 130. For example, if the original executable file 130 has been modified by a patch, update, outside maintenance, or other means, after creation of the optimized executable file 130A, a synchronization module (not shown) can instruct the Delay-Loader Optimizer 150 to re-optimize the original executable file 130. Alternatively, the Delay-Loader Optimizer 150 itself can initiate re-optimization of the original executable file 130 upon determining that the original executable file 130 has been modified.

For example, it can be determined that the original executable file 130 has been modified if a date on which the original executable file 130 was “last modified” is after a date on which the optimized executable file 130 was last modified. In certain embodiments of the invention, the Delay-Loader Optimizer 150 can monitor the original executable file 130 for changes and automatically re-optimize the original executable file 130 as necessary. Alternatively, the original executable file 130 can be periodically examined to determine whether synchronization is necessary.

In the example of FIGS. 1 and 2, the imported functions Function1 141 and Function2 142 are located within DLL1 132; the imported function Function3 144 is located within DLL2 134; and the imported functions Function4 144, Function5 145 and Function6 146 are located within DLL3 136. As illustrated in FIG. 2, the IAT 202 of the original executable file 130 lists the names of each of DLL1 132, DLL2 132 and DLL3 133 and their respective functions 141-146. In the modified IAT 202A, the structure of the original IAT 202 is maintained, meaning that the offsets of each entry in the modified IAT 202A match those of the original IAT 202. However, at each offset in the modified IAT 202A, an original DLL name is replaced by “DelayLoadDLL” or an original function name is replaced by “DelayLoadFunction”.

Maintaining the structure of the original IAT 202 within the modified IAT 202A is an efficient way to re-direct each function call 204 within the optimized executable file 130A to DelayLoadFunction 156. By way of illustration, a function call 204 designed to access Function1 141 will reference the same offset (e.g. RVA2 206) within the modified IAT 202A as it would have in the original IAT 202, but will instead result in a call to DelayLoadFunction 156 when executed. In other embodiments, it may be desirable to re-direct function calls 204 to DelayLoadFunction 156 by using a differently modified IAT 202A, manipulating function calls 204 to explicitly reference DelayLoadFunction 156, creating look-up tables to manage the re-directions, etc. However, as will be explained in more detail below, the structure of the original IAT 202 can also be useful, in certain embodiments, to determine which delay-loaded DLL to load into memory 104 in response to an executed function call 204.

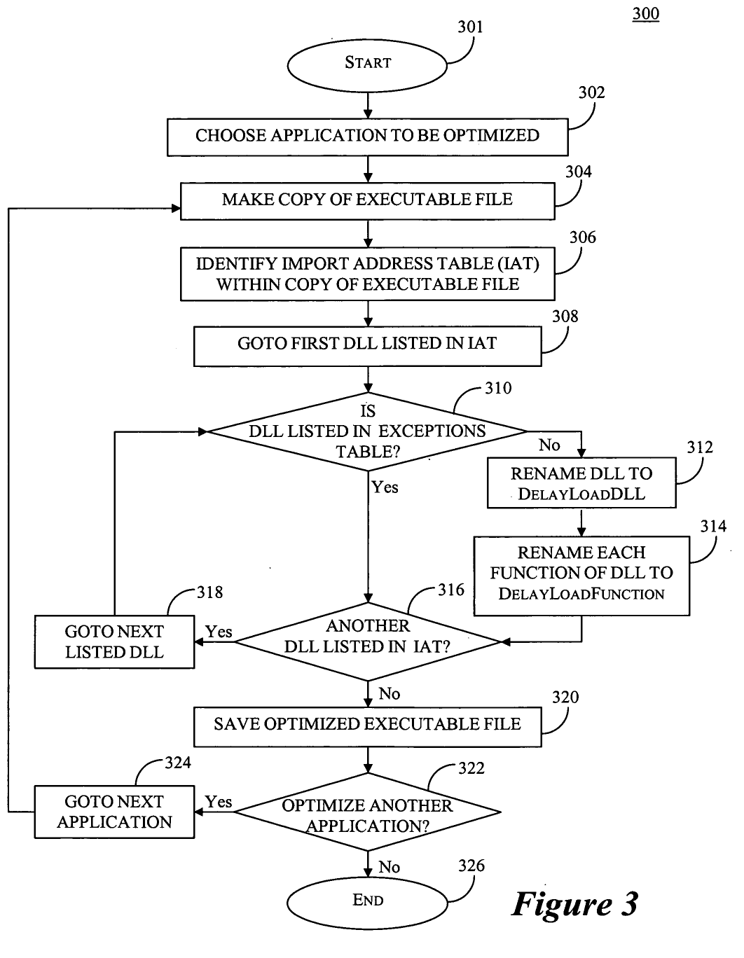

FIG. 3 is a flow chart illustrating an exemplary method 300 for creating an optimized executable file 130A. In certain embodiments, the method 300 may be performed by the Delay-Load Optimizer 150 described herein or another suitable program module. The exemplary method 300 begins at starting block 301 and advances to step 302 for selection of an application to be optimized. In accordance with the invention, any compiled application stored in or otherwise accessible by the computer system 100 can be selected for optimization.

Available applications may be randomly selected for optimization or a decision may be made to optimize all available applications. Alternatively, applications may be ranked in terms of frequency of use and those applications that are most frequently used may be selected for optimization. As another example, the execution of some or all available applications may be monitored over time to identify those that require loading of rarely-used DLLs and such applications may be selected for optimization. Many other methods for selecting applications to be optimized will be readily apparent to those of ordinary skill in the art.

Accordingly, selection of an application to be optimized at step 302 may involve the application of simple selection criteria or implementation of more advanced monitoring and selection logic. For simplicity sake, the exemplary method of FIG. 3 assumes that applications will be selected for optimization one at a time. More advanced methods for optimizing multiple applications in parallel are entirely possible and could be incorporated into the invention by one of ordinary skill in the art. Therefore, the selection methods described herein are provided by way of example only and are not intended to limit the scope of the invention.

After an application is selected for optimization at step 302, a copy of the application's executable file is created at step 304. Within the copy of the executable file, the IAT is identified at step 306. Next, at step 308, the first DLL listed in the IAT is located. Then, at step 310, a determination is made as to whether the DLL is designated for exclusion from the delay-load optimization. In certain embodiments, an exclusion table (i.e., a look-up table or other suitable list) may be used to specify those DLLs that should not be delay-loaded. Other programming techniques known to a person of ordinary skill in the art may alternatively be used to exclude certain DLLs from being delay-loaded.

Certain DLLs may be designated for exclusion from the delay-load optimization at the outset. By way of example, Kernel32.dll, GDI32.dll, User32.dll and NT.dll are frequently used DLLs that should not, in most cases, be delay-loaded. It may be desirable to exclude certain DLLs from being delay-loaded with respect to one application program, but not another. In addition or in the alternative, certain DLLs may be designated for exclusion after it is determined that application and/or system performance has not been sufficiently improved by delay-loading such DLLs.

If it is determined at step 310 that the DLL is not designated for exclusion, the DLL is renamed to DelayLoadDLL at step 312 and each of its functions is renamed to DelayLoadFunction at step 314. From either step 314 (after renaming all functions of the DLL) or step 310 (if it is determined that the DLL is to be excluded), the method 300 advances to step 316 for a determination as to whether another DLL is listed in the IAT. If the IAT lists another DLL, the next listed DLL is located at step 318 and the exemplary method 300 then returns to step 310 and is repeated from that point as previously described. When it is finally determined at step 316 that no other DLL is listed in the IAT, the copy of the executable file is saved as an optimized executable file 130A at step 320.

After saving the optimized executable file 130A at step 320, a determination is made at step 322 as to whether another application is to be optimized. If so, the next application to be optimized is selected at step 324 and the exemplary method then returns to step 304. The exemplary method 300 is repeated from step 304, as previously described, for the newly selected application. When it is finally determined at step 322 that no other application is to be optimized, the exemplary method 300 terminates at end point 326.

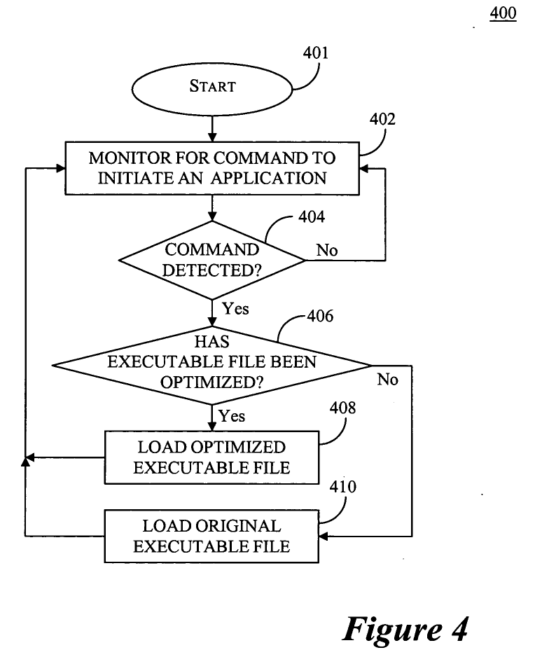

FIG. 4 is flow chart illustrating an exemplary method 400 for loading an optimized version of an executable file into memory 104 instead of an original (un-optimized) version of the executable file, to thereby achieve the delay-load optimization of the invention. In certain embodiments, the method 400 may be performed by the Delay-Load Optimizer 150 described herein or another suitable program module. For clarity, the following description of exemplary method 400 will make reference to the original executable file 130 and the optimized executable file 130A of FIGS. 1 and 2. The method 400 begins at starting block 401 and advances to step 402, where the computer operating system 126 is monitored for a command for initializing an application program 128. Then, at step 404, a determination is made as to whether a command for initializing an application program 128 has been detected.

If a command for initializing an application program 128 has been detected, the exemplary method 400 proceeds to step 406 for a determination as to whether the original executable file 130 of the application program 128 has been optimized. If the executable file 130 of the application program 128 has been optimized, the method advances to step 408, where the optimized executable file 130A is loaded into memory 104. If it is determined at step 406 that the original executable file 130 of the application program 128 has not been optimized, the method instead moves to step 410, where the original executable file 130 is loaded into memory 104. By way of example, a look-up table or other suitable list can be maintained and consulted to identify those executable files that have been optimized. Alternatively, determining whether the original executable file 130 has been optimized may be as simple as checking a directory of available files in persistent storage for the existence of an optimized file 130A. From either step 408 or step 410, the exemplary method 400 returns to step 402 to continue monitoring the operating system for another command for initializing an application program 128. The exemplary method 400 is thus repeated from step 402 in a continuous loop.

A person of ordinary skill in the art will appreciate that the exemplary method 400 of FIG. 4 is meant to illustrate the general concept that commands for loading an executable file 130 can be intercepted and caused instead to load an optimized executable file 130A. Many specific methods for intercepting and/or re-directing such commands are well known in the art. By way of example, all short-cuts and other links to an original application program 130 can be replaced (either automatically or manually) by links to the optimized executable program 130A. As another example, a file system filter driver or similar software function(s), which may or may not be incorporated in the Delay-Load Optimizer 150, may be used to redirect such commands.

The concept of a file system filter driver is well known in the art. Generally, a file system filter driver attaches to a file system driver and intercepts requests directed to the file system driver. A file system filter driver allows the addition of functionality beyond that provided by the file system driver. A file system filter driver might use the services of the file system driver or the services of other kernel-mode drivers to provide the additional functionality. A person of ordinary skill in the art will understand how to design and implement a file system filter driver to accomplish the functions described above with respect to FIG. 4 and, therefore, no particular programming techniques related thereto are described herein.

A person of ordinary skill in the art will also recognize that the NTFS file system used by certain operating systems, such as Windows NT, Windows 2000, Windows XP, and Windows 2003, includes native functionality known as “alternate data streams.” In certain embodiments of the invention, alternate data streams may be particularly useful for implementing optimized executable files 130A. Alternate data streams are hidden files that are linked to normal visible files (e.g., original executable files 130). Through the use of alternate data stream functionality, no additional logic needs to be provided for managing modified executable files 130A. A file system filter driver or other software function(s) may be configured for substituting an identifier (e.g., a filename) of an alternate data stream representing a modified executable file 130A for an identifier of an original executable file 130, when desired.

As previously described, loading the optimized executable file 130A into memory 104 will cause the DelayLoadDLL 154 and its DelayLoadFunction 156 to be mapped into memory 104. The DLLs listed in the original IAT 202, DLL1 131, DLL2 132 and DLL3 133, thus become delay-loaded DLLs. DelayLoadFunction 156 is then responsible for loading the delay-loaded DLLs into memory 104 in response to applicable executed function calls 204. In accordance with certain exemplary embodiments, DelayLoadFunction 156 is invoked whenever a function call 204 designed to access a function of a delay-loaded DLL is re-directed to it.

The exemplary method 300 of FIG. 3 or a similar method for creating an optimized executable file 130A may be performed each time it is desired to change the DLLs that are to be delay-loaded. More or fewer DLLs may be included in the optimized executable file 130A each time it is created, without the need to modify any of the application program source code. In certain embodiments, it may be desirable to save multiple different versions of the optimized executable file 130A, each having a different set of delay-loaded DLLs. As an example, multiple versions of the optimized executable file 130A may be stored as multiple alternate data streams of the original executable file 130 and can be managed by a file system filter driver designed to load the appropriate version depending on certain operating environment conditions or system usage patterns. Of course, at any time it is desired to disable the delay-load optimization of the invention, the original executable file 130 may simply be loaded into memory 104 in response to a command for initiating the application program 128.

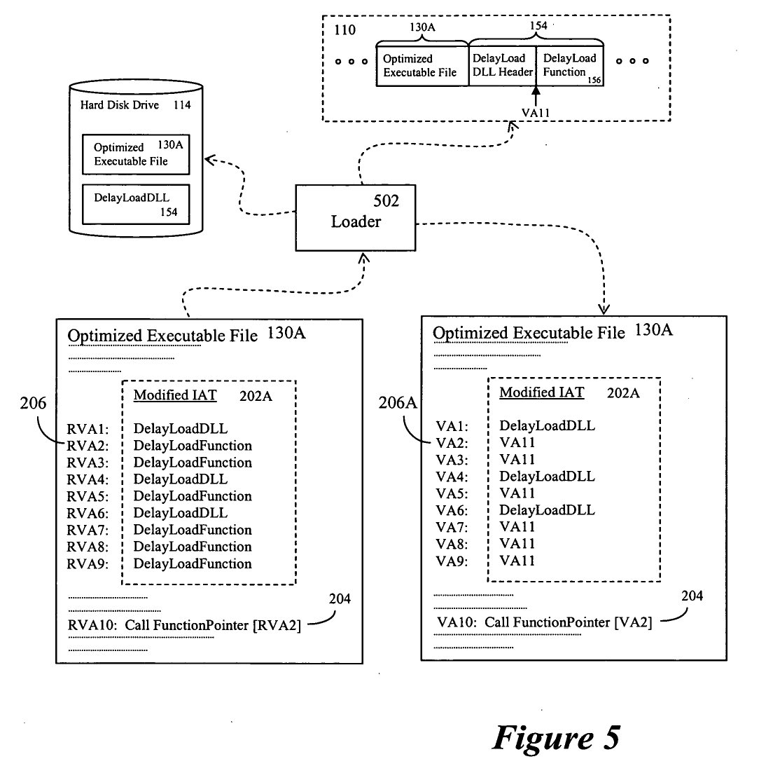

FIG. 5 is a block diagram showing, in the abstract, certain operations performed by the operating system's loader module when the optimized executable file 130A is initialized. During initialization, the optimized executable file 130A is loaded into memory 104 and the operating system's loader module parses the modified IAT 202A to determine the location in persistent storage (e.g., on disk) of each listed DLL, so that such DLLs can be mapped into memory 104. As a result of the modified IAT 202A, DLL1 131, DLL2 132 and DLL3 133 will not be mapped into memory 104 when the modified executable file 130A is initialized. Instead, DelayLoadDLL 154 will be mapped into memory 104.

After mapping DelayLoadDLL 154 into memory 104, the loader will replace each function name or ordinal in the modified IAT 202A with a function pointer that points to the virtual address at which DelayLoadFunction 156 is loaded. As shown in FIG. 5, each instance of the function name “DelayLoadFunction” within the modified IAT 202A is replaced by a pointer to virtual address VA11. The loader will also “fix-up” the optimized executable file 130A, meaning that all offsets (e.g., RVA1-RVA10) will be replaced by in-memory addresses (e.g., virtual addresses VA1-VA10). In particular, note that the exemplary offset RVA2 206 is replaced by exemplary in-memory address VA2 206A and that the exemplary function call 204 is changed to reference in-memory address VA2 instead of offset R VA2.

FIG. 6 is a block diagram illustrating, in the abstract, certain operations performed when a delay-loaded DLL is loaded into memory 104 in response to an executed function call. A function call 204 within the optimized executable file 130A works through the function pointers stored in the modified IAT 202A. As described previously, each function pointer is stored at a particular address within the modified IAT 202A, which can be accessed in several ways, such as by a direct call to that address or via a jmp thunk table. After the optimized executable file 130A has been initialized and the loader 302 has completed all “fix-ups,” the exemplary function call 204 references the in-memory address VA2 206A within the modified IAT 202A. When this function call 204 is executed, control is passed to the function referenced by the function pointer stored at in-memory address VA2 206A. The function pointer stored at in-memory address VA2 206A references the function loaded into memory 104 at virtual address VA11, i.e., DelayLoadFunction 156.

In response to the function call 204, DelayLoadFunction 156 is executed to determine which function the function call 204 intended to call (and would have called, but for the changes made in the modified IAT 202A). After identifying the intended function, DelayLoadFunction 156 causes the applicable DLL to be loaded into memory 104 and transfers processing control to the intended function, if such DLL and the intended function are available. In the example of FIG. 6, DLL1 131 is loaded into memory 104 after DelayLoadFunction 156 determines that Function1 141 is the intended function. Of course, loading DLL1 131 into memory 104 causes both Function1 141 and Function2 142 to be loaded into memory 104, e.g., at virtual address VA12 and virtual address VA13, respectively.

After DLL1 131 is loaded into memory 104, DelayLoadFunction 156 replaces the function pointer at in-memory address VA2 206A in the modified IAT 202A with a pointer to the in-memory address (e.g., VA12) of the intended function, i.e., Function1 141. Subsequent function calls made through in-memory address VA2 206A will thus access Function1 141 and not DelayLoadFunction 156. Additional details regarding the processing methods performed by DelayLoadFunction 156 are described below with reference to FIG. 7.

FIG. 7 is a flow chart illustrating an exemplary method 700 for loading a delay-loaded DLL into memory 104 in response to an executed function call. In certain embodiments, the method 700 may be performed by the DelayLoadFunction 156 described herein or another suitable program module. The exemplary method 700 begins at starting block 701 and proceeds to step 702, where the stack register of the operating system 126 is examined to determine the in-memory address of the last-executed function call. A person of ordinary skill in the art will appreciate that the last-executed function call should be the last-executed instruction in the stack register.

Next, at step 704, the code of the last-executed function call is located and examined to determine the in-memory address of the referenced function pointer. Again, the last-executed function call was originally intended to access a function (referred to herein as the “intended function”) of a delay-loaded DLL, via a function pointer in the IAT 202. However, the last-executed function call was redirected to DelayLoadFunction 156 due to the modified IAT 202A. After the virtual address of the referenced function pointer is determined at step 704, the method 700 moves to step 706.

At step 706, the offset of the referenced function pointer is determined. A person of ordinary skill in the art will understand that the offset (e.g., RVA) of the referenced function pointer can easily be determined by subtracting the base address of the optimized executable file 130A from the in-memory address of the referenced function pointer. Next at step 708, the original executable file 130 is accessed from persistent storage and the original IAT 202 is examined to determine the function name stored at the offset that was determined at step 706. As explained previously, the original IAT 202 will include a function name (or ordinal) at the offset, since the original executable file 130 has not been loaded into memory 104. Accordingly, the name of the function stored at the determined offset should correspond to the name of the intended function.

Next at step 710, the DLL corresponding to the intended function is identified. Based on the structure of the typical IAT 202, the name of the DLL corresponding to the intended function should be easily identified. This identified DLL should correspond to the delay-loaded DLL. After identifying the delay-loaded DLL, an attempt is made at step 712 to load it into memory 104.

A person of ordinary skill in the art will appreciate that Windows provides the API call “LoadLibrary” for loading DLLs into memory 104. Other operating systems may provide similar or equivalent API calls. Other well-known programming techniques may also be employed for loading a delay-loaded DLL into memory 104. For example, a new function can be created for loading a delay-loaded DLL, if desired. It will be appreciated by a person of ordinary skill in the art that the operating system 126 may raise a software exception (error code) if a LoadLibrary or similar loading function is performed with regard to the delay-loaded DLL, but the delay-loaded DLL is not available to be loaded into memory 104. Such a software exception may be avoided if it can otherwise be determined that the delay-loaded DLL is not available prior to calling the loading function.

At step 714, it is determined whether the delay-loaded DLL has been loaded into memory 104. If the delay-loaded DLL is not available, any exception raised may need to be trapped to prevent the process from being terminated. Exceptions can be trapped using an appropriate structured exception handling frame or other methods familiar to those of skill in the art. Accordingly, if it is determined at step 714 that the delay-loaded DLL could not be loaded into memory 104, any software exception is trapped at step 716 and processing control is transferred at step 718 to the in-memory address following the last-executed function call in the optimized executable file 130A. From step 718, the exemplary method 700 ends at end point 730.

However, if it is determined at step 714 that the delay-loaded DLL is successfully loaded into memory 104, an attempt is then made at step 720 to determine the in-memory address of the intended function. A person of ordinary skill in the art will appreciate that Windows provides the API call “GetProcAddress” for determining the in-memory address of a function and that other operating systems may provide similar or equivalent API calls. Alternatively other well-known programming techniques may be employed to determine the in-memory address of the intended function. Next at step 722, a determination is made as to whether an in-memory address for the intended function could be located. A person of ordinary skill in the art will further appreciate that the intended function may not be available, even though the delay-loaded DLL is available. For example, an older version of the delay-loaded DLL may be available which does not include the intended function.

If it is determined at step 722 that the intended function is not available in memory 104, the exemplary method 700 moves to step 724, where any software exception is trapped and the delay-loaded DLL is released from memory 104 (assuming that it is not otherwise needed at this time). From step 724, the exemplary method 700 moves to step 718, where processing control is transferred to the in-memory address following the last-executed function call in the optimized executable file 130A. From step 718, the exemplary method 700 ends at end point 730. However, if the in-memory address of the intended function can be determined at step 722, the exemplary method 700 advances to step 726. At step 726, the pointer to DelayLoadFunction 156 in the modified IAT 202A (which is located at the in-memory address of the last-executed function call) is replaced with a pointer to the in-memory address of the intended function. Replacing the function pointer in the modified IAT 202A insures that all subsequent function calls made through that pointer are directed to the intended function and are not redirected to DelayLoadFunction 156. After replacing the function pointer in step 726, the method moves to step 728, where processing control is transferred to the intended function (e.g., by way of a jmp command or other suitable programming technique). After transferring processing control to the intended function, the exemplary method ends at end point 730.

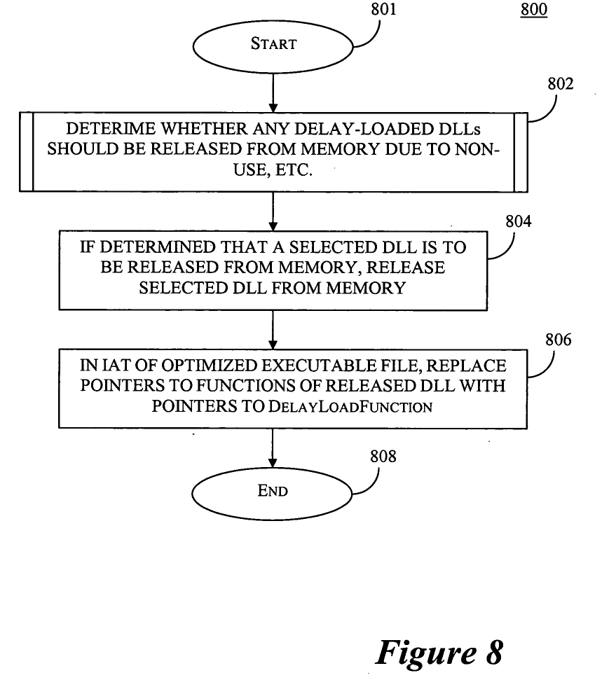

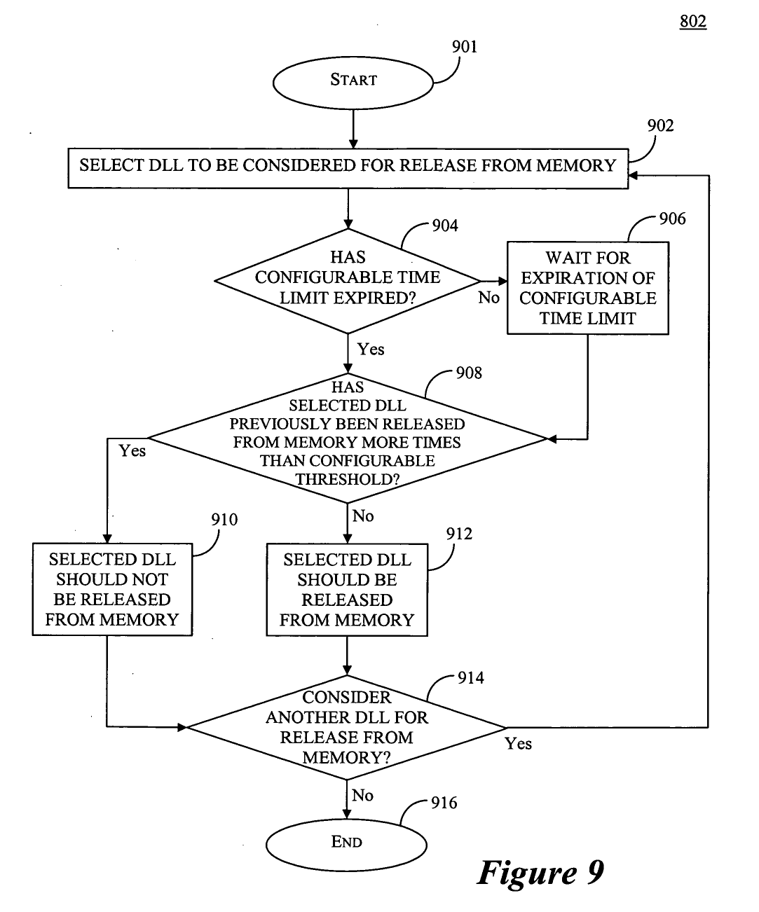

FIG. 8 is a flow chart illustrating an exemplary method 800 for unloading a delay-loaded DLL from memory 104. In certain embodiments, the method 800 may be performed by the Delay-Load Optimizer 150 described herein or another suitable program module. The exemplary method 800 begins at starting block 801 and proceeds to step 802 for a determination of whether any a delay-loaded DLLs should be released from memory 104. There may be several situations in which it is desirable to release a particular delay-loaded DLL from memory 104, for example, due to actual or expected non-use of the DLL. An exemplary method for determining when to unload a delay-loaded DLL from memory 104 is described below with respect to FIG. 9.

If it is determined that a delay-loaded DLL should be released, that DLL is released from memory 104 at step 804. A person of ordinary skill in the art will appreciate that Windows provides the API call “FreeLibrary” for unloading DLLs from memory 104. Other operating systems may provide similar or equivalent API calls. Alternatively, other functions or programming techniques may be used to release a delay-loaded DLL from memory 104. After the delay-loaded DLL is released from memory 104, the method moves to step 806. At step 806, the modified IAT 202A of the optimized executable file 130A (which remains loaded into memory 104) is accessed and each pointer therein to a function of the released DLL is replaced with a pointer to the DelayLoadLibrary function 156.

After replacing the function pointers within the modified IAT 202A of the optimized executable file 130A, the exemplary method 800 ends at step 808. By unloading a delay-loaded DLL from memory 104 according to the exemplary method 800, function calls designed to call the functions of that DLL will again be redirected to the DelayLoadFunction 156. In this manner the delay-loaded DLL can be reloaded on demand, when needed again. In the mean time, system resources are freed and can be reallocated for other purposes.

FIG. 9 is a flow chart illustrating an exemplary method 802 (from FIG. 8) for determining when to unload a delay-loaded DLL from memory 104. In certain embodiments, the method 802 may be performed by the Delay-Load Optimizer 150 described herein or another suitable program module. The exemplary method 802 begins at starting block 901 and proceeds to step 902 for selection of a DLL to be considered for release from memory 104. The selected DLL may be chosen randomly or based on some predetermined selection criteria. In certain embodiments, any DLL can be considered for release from memory 104, even if such DLL was not previously delay-loaded. However, at least in some embodiments, if a particular DLL was not delay-loaded, it is likely known or expected to be needed in memory 104 and therefore need not be considered for release.

Next at step 904, a determination is made as to whether a configurable time limit has expired. By way of illustration, if the selected DLL has very recently been loaded into memory 104 (e.g., within last 10 minutes or so), it may be premature to assume that at least one of its functions will not be needed again during the current session. The configurable time limit may be set at any desired length of time and may be changed at any time. If it is determined at step 904 that the configurable time limit has not expired, the method 802 moves to step 906 to await expiration of the time period. After waiting for the configurable time period to expire at step 906, or if it is determined at step 904 that the configurable time limit has already expired, the exemplary method 802 next moves to step 908.

At step 908, a determination is made as to whether the selected DLL has previously been released from memory 104 more than a configurable threshold number of times. By way of illustration, if the selected DLL has been released from memory 104 and reloaded into memory 104 multiple times (e.g., 3 times), at least one of its functions is likely being called often enough that it should not be released from memory 104 again during the current session. Conversely, if the selected DLL has not been released from memory 104 and reloaded into memory 104 multiple times (e.g., 3 times), it may be that the DLL is not frequently needed during the current session. The configurable threshold may be set at any desired number and may be changed at any time.

If it is determined at step 908 that the selected DLL has previously been released from memory 104 more than the configurable threshold amount of times, a conclusion is drawn at step 910 that the selected DLL should not be released from memory 104. If it is determined at step 908 that the selected DLL has not previously been released from memory 104 more than the configurable threshold amount of times, a conclusion is drawn at step 912 that the selected DLL should be released from memory 104. From either step 910 or 912, the exemplary method 802 advances to step 914, where it is determined whether another DLL should be considered for release from memory 104. If another DLL is to be considered, the method returns to step 902 and is repeated from that point as described above. When it is finally determined at step 914 that no other DLL should be considered for release from memory 104, the exemplary method 802 ends at step 916.

As will be appreciated, the exemplary method 802 presumes that all delay-loaded DLLs should be released from memory 104, by default, after expiration of a certain time limit. As an exception to the default, a delay-loaded DLL should not be released from memory 104 if it has previously been released from and reloaded into memory 104 multiple times. Still, many other methods for determining whether to release a delay-loaded DLL from memory 104 are contemplated by the invention. For example, a determination can be made as to whether a selected DLL appears within the working set of a process within a certain period of time and, if not, the DLL may be released from memory 104. As another example, all DLL's may be released from memory 104 at certain configurable time intervals (e.g., every 10 minutes or so). Other heuristic approaches could also be used for determining whether a delay-loaded DLL should be released from memory 104.

Based on the foregoing, it can be seen that the invention provides systems and method for delay-loading components of a compiled application program. Thus, components of an application program 128 can be delay-loaded without modification of the application program source code. A person of ordinary skill in the art will appreciate that the methods of the invention can be embodied as computer-executable instructions stored on computer-readable media and can be implemented using programming techniques and/or functions other than those specifically described herein. Many other modifications, features and embodiments of the invention will become evident to those of skill in the art. Furthermore, the fictitious program, component and function names used herein, such as Delay-Load Optimizer, DelayLoadDLL and DelayLoadFunction, were chosen for ease of reference and are used by way of illustration and not limitation.

It should also be appreciated, therefore, that many aspects of the invention were described above by way of example only and are not intended as required or essential elements of the invention unless explicitly stated otherwise. Accordingly, it should be understood that the foregoing relates only to certain exemplary embodiments of the invention and that numerous changes may be made therein without departing from the spirit and scope of the invention as defined by the following claims. It should be further understood that the invention is not restricted to the illustrated embodiments and that various other modifications can be made within the scope of the following claims.

What is claimed is:

1. A method for delay-loading a component of a compiled application program, said compiled application program stored in a persistent storage of a computer system and comprising said component and an executable file, the method comprising:
creating a copy of the executable file;
within the copy of the executable file, identifying an import address table containing a reference to said component and a reference to an imported function included within said component;
modifying said import address table by replacing the reference to said component with a reference to a delay-load component and replacing the reference to the imported function with a reference to a delay-load function included within said delay-load component, wherein said delay-load function is designed to load said component into a memory of the computer system upon execution of a function call designed to access the imported function; and
saving the copy of the executable file in the persistent storage.

2. A computer-readable medium having stored thereon computer-executable instructions for performing the method of claim 1.

3. The method of claim 1, further comprising the step of loading the copy of the executable file into the memory in response to a command for initializing the compiled application program,
whereby said delay-load component will be loaded into the memory instead of the component upon initialization of said compiled application program.

4. The method of claim 3, wherein the step of loading the copy of the executable file into the memory in response to the command for initializing the compiled application program is performed by file system filter driver.

5. The method of claim 3, wherein the function call designed to access the imported function refers to an in-memory address within the modified import address table that stores the reference to the delay-load function, whereby execution of said function call causes the delay-load function to be executed; and
wherein the delay-load function performs the steps of:
locating and examining said function call within the copy of the executable file loaded in the memory to determine the in-memory address within the modified import address table to which said function call refers,
determining the offset corresponding to the determined in-memory address,
examining the import address table of the original executable file stored in the persistent storage, at the offset, to identify the imported function and the component, and
attempting to load said component into the memory.

6. The method of claim 5, wherein the delay-load function further performs the step of examining a stack register to determine an in-memory address at which said function call is located.

7. The method of claim 5, wherein the delay-load function further performs the steps of:
in response to loading the component into the memory, determining an in-memory address of the imported function;
at the determined in-memory address within the modified import address table, replacing the reference to the delay-load function with a pointer to the in-memory address of the imported function; and
transferring processing control to the imported function.

8. The method of claim 7, further comprising the step of releasing the component from the memory in response to determining that the imported function has not been called within a configurable time limit.

9. The method of claim 8, further comprising the step of, at the determined in-memory address within the modified import address table, replacing the pointer to the in-memory address of the imported function with a pointer to an in-memory address of the delay-load function.

10. A computer-readable medium having stored thereon computer-executable instructions for performing the method of claim 9.

11. The method of claim 7, further comprising the step of releasing the component from memory in response to determining that the imported function has not been called within a configurable time limit and has not previously been released from memory more than a configurable threshold number of times.

12. The method of claim 11, further comprising the step of, at the determined in-memory address within the modified import address table, replacing the pointer to the in-memory address of the imported function with a pointer to an in-memory address of the delay-load function.

13. A computer-readable medium having stored thereon computer-executable instructions for performing the method of claim 12.

14. The method of claim 5, wherein the delay-load function further performs the steps of:
in response to loading the component into the memory, determining that the imported function is not available in the memory; and
transferring processing control to an in-memory address following the function call within the copy of the executable file.

15. The method of claim 14, further comprising the step of trapping a software exception raised in response to the determination that the imported function is not available in the memory.

16. The method of claim 5, further comprising the step of transferring processing control to an in-memory address following the function call within the copy of the executable file, in response to determining that the component is not available to be loaded into the memory.

17. The method of claim 16, further comprising the step of trapping a software exception raised in response to the determination that the component is not available to be loaded into the memory.

18. The method of claim 1, wherein the copy of the executable file is saved as an alternate data stream of the executable file.

19. A computer-readable medium having stored thereon computer-executable code comprising:
an optimized executable file of a compiled application program, said optimized executable file configured to delay-load a component of said application program;
wherein said optimized executable file includes an import address table that has been modified to replace a reference to said component with a reference to a delay-load component and to replace a reference to an imported function included within said component with a reference to a delay-load function included within said delay-load component; and
wherein said delay-load function comprises computer-executable instructions for loading said component into memory upon execution of a function call designed to access the imported function.

20. The computer-readable medium of claim 19, wherein the component comprises a DLL.

21. The computer-readable medium of claim 19, wherein the reference to the component comprises a component name; and
wherein the reference to the imported function comprises an imported function name.

22. The computer-readable medium of claim 19, wherein the reference to the component comprises a component ordinal; and
wherein the reference to the imported function comprises an imported function ordinal.

23. The computer-readable medium of claim 19, wherein the optimized executable file comprises an alternate data stream of an original executable file.

24. A computer-readable medium having stored thereon computer-executable instructions for delay-loading a component of a compiled application program, said compiled application program comprising said component and an optimized executable file, said optimized executable file being loaded into a memory of a computer system upon initialization of said compiled application program and including a modified import address table in which a reference to said component has been replaced with a reference to a delay-load component and a reference to an imported function included within said component has been replaced with a reference to a delay-load function included within said delay-load component, said computer-executable instructions for performing the steps comprising:
locating and examining a last-executed function call within the optimized executable file to determine an in-memory address within the modified import address table to which said function call refers;
determining an offset corresponding to the determined in-memory address;
examining an import address table of an original executable file stored in persistent storage of the computer system, at the offset, to identify the imported function and the component; and
attempting to load said component into the memory.

25. The computer-readable medium of claim 24, wherein the computer-executable instructions are further designed to perform the step of examining a stack register to determine an in-memory address within the optimized executable file at which said function call is located.

26. The computer-readable medium of claim 24, wherein the computer-executable instructions are further designed to perform the steps of:
in response to loading the component into the memory, determining an in-memory address of the imported function;
at the determined in-memory address within the modified import address table, replacing the reference to the delay-load function with a pointer to the in-memory address of the imported function; and
transferring processing control to the imported function.

27. The computer-readable medium of claim 24, wherein the computer-executable instructions are further designed to perform the steps of:
in response to loading the component into the memory, determining that the imported function is not available in the memory; and
transferring processing control to an in-memory address following the function call within the optimized executable file.

28. The computer-readable medium of claim 27, wherein the computer-executable instructions are further designed to perform the step of trapping a software exception raised in response to the determination that the imported function is not available in the memory.

29. The computer-readable medium of claim 24, wherein the computer-executable instructions are further designed to perform the step of transferring processing control to an in-memory address following the function call within the optimized executable file, in response to determining that the component is not available to be loaded into the memory.

30. The computer-readable medium of claim 29, wherein the computer-executable instructions are further designed to perform the step of trapping a software exception raised in response to the determination that the component is not available to be loaded into the memory.

31. A computer system for delay-loading a component of a compiled application program, said compiled application program comprising an executable file and said component, said component including at least one imported function, the computer system comprising:
a memory being logically divided into a plurality of in-memory addresses; and
a persistent storage for storing said compiled application program and a delay-load component that includes a delay-load function designed for loading said component into the memory upon execution of a function call designed to access the imported function; and
a processor for executing computer-executable instructions for:
creating a copy of the executable file,
within the copy of the executable file, identifying an import address table containing a reference to said component and a reference to said imported function,
modifying said import address table by replacing the reference to said component with a reference to the delay-load component and replacing the reference to the imported function with a reference to the delay-load function, and
saving the copy of the executable file to the persistent storage.

32. The computer system of claim 31, wherein the processor executes further computer-executable instructions for loading the copy of the executable file into the memory in response to a command for initializing the compiled application program,
whereby said delay-load component will be loaded into the memory instead of the component upon initialization of said compiled application program.

33. The computer system of claim 32, wherein the function call designed to access the imported function refers to an in-memory address within the modified import address table that stores the reference to the delay-load function, whereby execution of said function call causes the delay-load function to be executed; and
wherein the delay-load function comprises computer-executable instructions for:
locating and examining said function call within the copy of the executable file loaded in the memory to determine the in-memory address within the modified import address table to which said function call refers,
determining an offset corresponding to the determined in-memory address,
examining the import address table of an original version of the executable file stored in the persistent storage, at the offset, to identify the imported function and the component, and
attempting to load said component into the memory.

34. The computer system of claim 33, wherein the delay-load function further comprises computer-executable instructions for examining a stack register to determine an address within the copy of the executable file loaded in memory at which said function call is located.

35. The computer system of claim 33, wherein the delay-load function further comprises computer-executable instructions for:
determining an in-memory address of the imported function, in response to loading the component into the memory;
at the determined in-memory address within the modified import address table, replacing the reference to the delay-load function with a pointer to the in-memory address of the imported function; and
transferring processing control to the imported function.

36. The computer system of claim 35, wherein the processor executes further computer-executable instructions for releasing the component from the memory in response to determining that the imported function has not been called within a configurable time limit.

37. The computer system of claim 36, wherein the processor executes further computer-executable instructions for, at the determined in-memory address within the modified import address table, replacing the pointer to the in-memory address of the imported function with a pointer to an in-memory address of the delay-load function.

38. The computer system of claim 35, wherein the processor executes further computer-executable instructions for releasing the component from the memory in response to determining that the imported function has not been called within a configurable time limit and the component has not previously been released from the memory more than a configurable threshold number of times.

39. The computer system of claim 38, wherein the processor executes further computer-executable instructions for, at the determined in-memory address within the modified import address table, replacing the pointer to the in-memory address of the imported function with a pointer to an in-memory address of the delay-load function.

40. The computer system of claim 33, wherein the delay-load function further comprises computer-executable instructions for:
in response to loading the component into the memory, determining that the imported function is not available in the memory; and
transferring processing control to an in-memory address following the function call code within the copy of the executable file.

41. The computer system of claim 40, wherein the delay-load function further comprises computer-executable instructions for trapping a software exception raised in response to the determination that the imported function is not available in the memory.

42. The computer system of claim 33, wherein the delay-load function further comprises computer-executable instructions for transferring processing control to an in-memory address following the function call within the copy of the executable file, in response to determining that the component is not available to be loaded into the memory.

43. The computer system of claim 42, wherein the delay-load function further comprises computer-executable instructions for trapping a software exception raised in response to the determination that the component is not available to be loaded into the memory.

44. The computer system of claim 31, wherein the copy of the executable file is saved as an alternate data stream.
